(19) United States
(12) Patent Application Publication
(10) Pub. No.: US 2012/0166571 A1
(43) Pub. Date: Jun. 28, 2012

(54) APPARATUS AND METHOD FOR PROVIDING MOBILE SERVICE IN A MOBILE COMMNUCATION NETWORK

(76) Inventor: SUNG-IL JIN, Seoul (KR)

(21) Appl. No.: 13/313,545

(22) Filed: Dec. 7, 2011

(30) Foreign Application Priority Data
Dec. 23, 2010 (KR) 10-2010-0133351

(51) Int. Cl. G06F 15/167

(52) U.S. Cl. 709/213

(57) ABSTRACT

Apparatus, system, and method for providing a mobile service to a mobile node in a mobile communication network. In order to provide the mobile service, a request may be received from a mobile node for connecting to a mobile router. When the mobile node is authorized to access the mobile router, the authorized mobile node may be connected to a file server in the mobile router. Then, a storage service may be provided to the authorized mobile node.

### CROSS REFERENCE TO PRIOR APPLICATIONS

The present application claims priority under 35 U.S.C. §119 to Korean Patent Application No. 10-2010-0133351 (filed on Dec. 23, 2010), which is hereby incorporated by reference in its entirety.

### FIELD OF THE INVENTION

Apparatuses and methods consistent with the present invention relate to providing a mobile service in a mobile communication network, and more particularly, to a mobile service apparatus and method for providing both a routing function and a network storage function.

### BACKGROUND OF THE INVENTION

Recently, mobile communication technologies have been advanced dramatically. Such advanced mobile communication technologies allow the Internet to be accessible practically everywhere. Lately, users desire seamless reception of such a mobile communication service while traveling in a vehicle such as a train, a ship, or an airplane.

Such a mobile communication service may be provided through a mobile router. The mobile router provides mobility to mobile nodes within a related mobile network. For example, a mobile router allows mobile nodes to access the Internet through a mobile communication network using a high speed downlink packet access (HSDPA) protocol or a broadband wireless communication network protocol such as WiMAX while traveling even at a high speed.

As described above, demand of such wireless services has been abruptly increased. In order to satisfy such demand, complexity of a related network has been gradually increased.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, there may be provided a mobile router, a mobile service system and a mobile service method, that facilitate reduced network complexity.

In accordance with an embodiment of the present invention, a mobile service apparatus may be provided for providing a mobile service to a mobile node in a mobile communication network. The apparatus may include a routing function unit and a storage function unit.

The routing function unit may be configured to function as a mobile access point for the mobile node. The storage function unit may be configured to authorize the mobile node to access the mobile service apparatus, and configured to provide a storage service to the authorized mobile node.

The storage function unit may include a network-attached storage that may be configured to provide a file-level data storage service. The storage function unit may further include a storage unit and a file server unit.

The storage unit may be configured to store files. The file server unit may be configured to control at least one of a file transmission and a file reception between the authorized mobile node and the mobile service apparatus.

The mobile service apparatus may further include a routing controller. The routing controller may be configured to communicate a variety of commands between the routing block and the storage block.

The routing function unit may include a processing unit. The processing unit may be configured to transmit a data packet from the authorized mobile node to the storage block if the data packet is related to the storage service.

In accordance with another embodiment of the present invention, a system may be provided for providing a mobile service in a mobile communication network. The system may include a mobile router. The mobile router may be configured to provide both an Internet access and a storage service to a mobile node in the mobile communication network. The mobile node may be configured to connect to the mobile router for the Internet access, and may be configured to receive the storage service from the mobile router.

The mobile router may include a routing function unit and a storage function unit. The routing function unit may be configured to function as a mobile access point for the mobile node. The storage function unit may be configured to authorize the mobile node to access the mobile router to provide the storage service to the authorized mobile node.

The storage function unit may include a network-attached storage that may be configured to provide a file-level data storage service. The storage function unit may further include a storage unit and a file server unit.

The storage unit may be configured to store files. The file server unit may be configured to control at least one of a file transmission and a file reception between the authorized mobile node and the mobile router.

The routing function unit may include a processing unit. The processing unit may be configured to transmit a data packet from the authorized mobile node to the storage block if the data packet is related to the storage service.

The mobile router may further include a routing controller. The routing controller may be configured to communicate a variety of commands between the routing block and the storage block.

The mobile node may include a connection unit and a file sharing unit. The connection unit may be configured to perform a connection to the mobile router. The file sharing unit may be configured to request the storage service to be provided to the mobile router, and configured to receive the storage service from the mobile router.

The mobile node may further include a network drive generation unit. The network drive generation unit may be configured to generate a network drive when the connection of the mobile node to the mobile router has been established.

The file sharing unit may include a connection module. The connection module may be configured to connect to a file server in the mobile router.

In accordance with still another embodiment of the present invention, a method may be provided for providing a mobile service in a mobile communication network. In order to provide the mobile service, a request may be received from a mobile node for connecting to a mobile router. The mobile node may be authorized to access the mobile router. The authorized mobile node may be connected to a file server in the mobile router. Then, a storage service may be provided to the authorized mobile node.

The storage service may include a file-level data storage service.

When the connection of the authorized mobile node to the file server has been established, a signal path may be generated from the authorized mobile node to the file server.

In order to generate the signal path from the authorized mobile node to the file server, a network drive may be generated in the authorized mobile node to connect to the file server.

Furthermore, a status of a connection module in the authorized mobile node may be converted into an active status to connect the authorized mobile node to the file server.

In order to provide the storage service to the authorized mobile node, files transmitted from the authorized mobile node may be stored in the file server. Then, the authorized mobile node may receive a desired file from the file server.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates an example of a network system in accordance with an embodiment of the present invention;

FIG. 2 illustrates an example of a system for providing a mobile service in a mobile communication network, in accordance with an embodiment of the present invention;

FIG. 3 illustrates a mobile service apparatus in accordance with an embodiment of the present invention;

FIG. 4 illustrates a mobile terminal in accordance with an embodiment of the present invention;

FIG. 5 illustrates a mobile service method of a mobile terminal, in accordance with an embodiment of the present invention; and

FIG. 6 illustrates a mobile service method of a mobile router, in accordance with an embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with an embodiment of the present invention, a mobile service apparatus and method may provide both a routing function and a storage service to a mobile node in a mobile communication network. The mobile service apparatus may be referred to as a mobile router. The mobile router may perform authorization of a mobile node upon receiving a request from the mobile node for connecting to the mobile router. The authorized mobile node may be allowed to connect to a file server in the mobile router when the authorization is completed. Then, the mobile router may provide a storage service to the allowed mobile node.

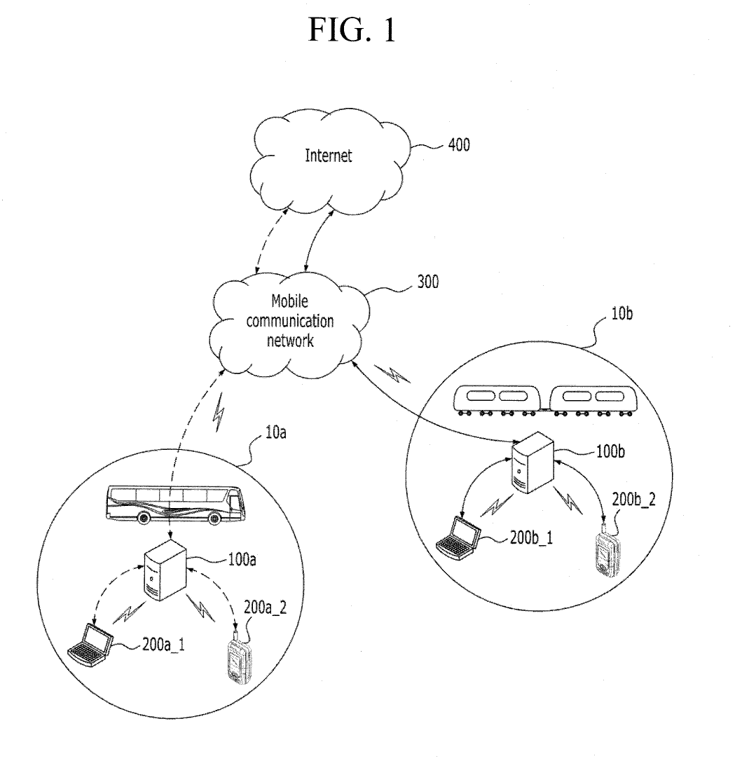

FIG. 1 illustrates an example of a network system in accordance with an embodiment of the present invention.

Referring to FIG. 1, a network system may include a first vehicle network 10a, a second vehicle network 10b, a mobile communication network 300, and the Internet 400. The first and second vehicle networks 10a and 10b may be networks in a moving vehicle such as a bus, a train, an airplane, or a ship.

The first vehicle network 10a may include a first mobile router 100a and one or more mobile terminals 200a_1 and 200a_2 such as a laptop and a cellular phone. The first mobile router 100a may provide mobility to the mobile terminals 200a_1 and 200a_2 such that the mobile terminals 200a_1 and 200a_2 can access the Internet 400 over the mobile communication network 300 while travelling in a moving vehicle.

The second vehicle network 10b may include a second mobile router 100b and one or more mobile terminals 200b_1 and 200b_2 such as a laptop and a cellular phone. The second mobile router 100b may provide mobility to the mobile terminals 200b_1 and 200b_2 such that the mobile terminals 200b_1 and 200b_2 can access the Internet 400 over the mobile communication network 300 while travelling in a moving vehicle.

The first and second mobile routers 100a and 100b may allow the mobile terminals 200a_1, 200b_1, 200a_2, and 200b_2 to access the Internet 400 through the mobile communication network 300 by using a high-speed downlink packet access (HSDPA) protocol or a broadband wireless access protocol such as WiMAX.

In accordance with an embodiment of the present invention, the first and second mobile routers 100a and 100b may provide a network-attached storage (NAS) service. The NAS service refers to a network storage service.

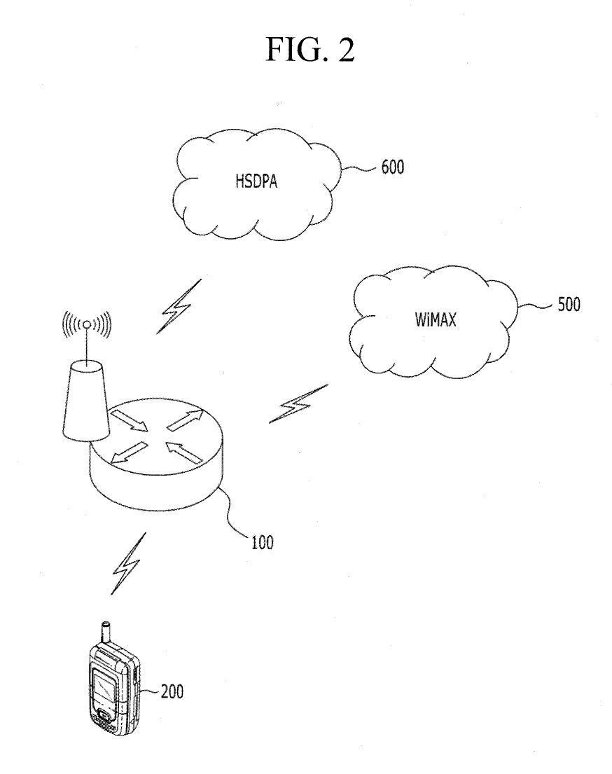

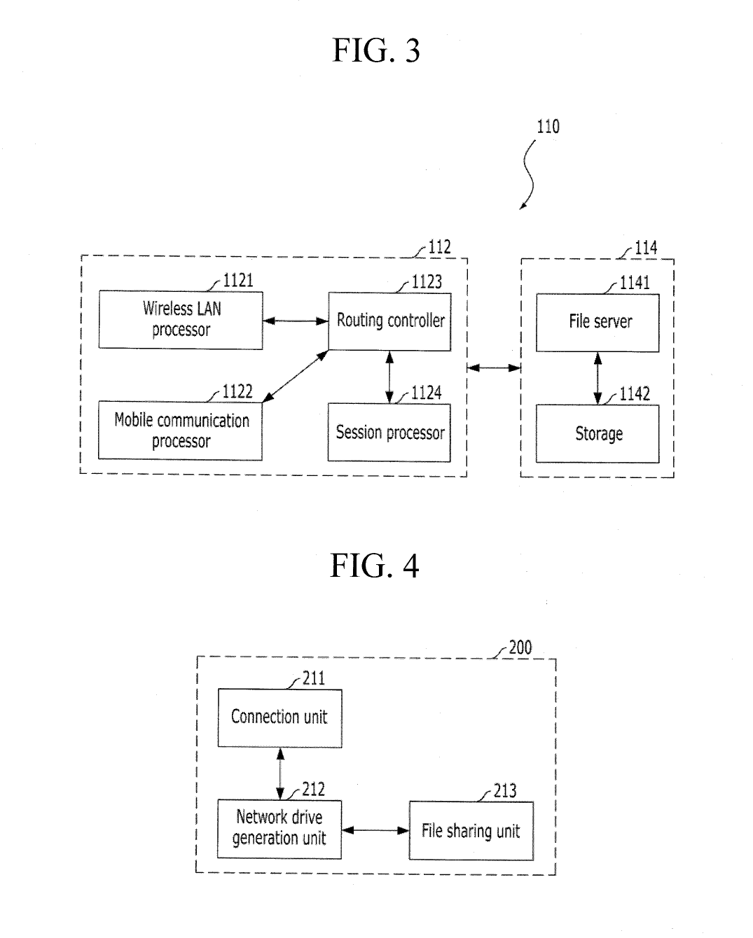

A mobile router in accordance with an embodiment of the present invention will be described below in detail with reference to FIGS. 2 and 3.

FIG. 2 illustrates an example of a system for providing a mobile service in a mobile communication network, in accordance with an embodiment of the present invention.

Referring to FIG. 2, the system may include a mobile router 100, a mobile terminal 200, and a variety of networks such as a WiMAX 500 and an HSDPA network 600.

The mobile router 100 may provide a mobile service to the mobile terminal 200 by accessing a variety of networks such as WiMAX 500 and HSDPA network 600. In other words, the mobile router 100 may provide a seamless mobile service to the mobile terminal 200 even when the mobile terminal 200 travels in a moving vehicle.

The mobile router 100 may also provide a NAS service to the mobile terminal 200. The mobile router 100 may use a file system to provide file-level data input/output. Therefore, the mobile router 100 may provide an environment where a plurality of mobile terminals can share files with each other.

The mobile router 100 may provide the NAS service to the mobile terminal 200 by connecting with a file server when the mobile terminal 200 connects to the mobile router 100. The file server may serve as an external hard disk with respect to the mobile terminal 200. Such a file server may provide improvement in terms of stability or data protection as compared to an actual contact-type external hard disk.

FIG. 3 illustrates a mobile service apparatus in accordance with an embodiment of the present invention.

The mobile service apparatus 110 illustrated in FIG. 3 may be a mobile router 100 or may be a part of the mobile router 100.

Referring to FIG. 3, the mobile service apparatus 110 may include a router function unit 112 configured to function as a mobile access point for a mobile terminal 200 and a NAS function unit 114 configured to provide a network storage service to the mobile terminal 200.

The router function unit 112 may include a wireless LAN processor 1121, a mobile communication processor 1122, a routing controller 1123, and a session processor 1124.

The wireless LAN processor 1121 may serve as an access point (AP) of the mobile terminal 200.

The mobile communication processor 1122 may serve as a mobile communication modem and provide an access to the mobile communication network 300.

The routing controller 1123 may interwork with any one or more of a file server 1141, the wireless LAN processor 1121, and the mobile communication processor 1122 to transmit data packets based on a determination of a packet transfer path for a session.

The session processor 1124 may provide a connection between a wireless LAN session and a mobile communication session. The session processor 1124 may perform a network address translation, maintain a session, and/or manage accessible users.

The NAS function unit 114 may include a file server 1141 and a storage 1142.

The file server 1141 may determine whether or not the mobile terminal 200 attempting to access the mobile router 100 is a user who can access the file server 1141 and authorize the mobile terminal 200 to access the file server 1141. The file server 1141 may process a NAS service related packet received from the router function unit 112, generate a response packet, and transmit a response packet to the mobile terminal 200.

The file server 1141 may communicate with the mobile terminal 200 through a protocol such as a network file system (NFS) or a common Internet file system (CIFS). The file server 1141 may store files in the storage 1142 and transfer files from the storage 1142 to the mobile terminal 200, according to a request from the mobile terminal 200 through the protocol.

The storage 1142 may store various files from a mobile terminal 200 that connect the mobile router 100.

FIG. 4 illustrates a mobile terminal in accordance with an embodiment of the present invention.

Referring to FIG. 4, the mobile terminal 200 may include a connection unit 211, a network drive generation unit 212, and a file sharing unit 213.

The connection unit 211 may enable the mobile terminal 200 to connect to the wireless LAN processor 1121 in the mobile router 100.

The network drive generation unit 212 may generate a network drive when the mobile terminal 200 connects to the mobile router 100 through the connection unit 211.

The file sharing unit 213 may access the file server 1141 through the network drive so as to store files in the file server 1141 or receive files from the file server 1141.

Alternatively, the file sharing unit 213 may include a connection module instead of the network drive, which has a program to enable the mobile terminal 200 to connect to the file server 1141. In this case, when the mobile terminal 200 attempts to connect to the mobile router 100, the connection module may operate to allow the mobile terminal 200 to connect the file server 1141.

Accordingly, in accordance with an embodiment of the present invention, the mobile terminal 200 may connect to the Internet through the mobile router 100 and receive a network storage service, without requiring a separate external hard disk for file storage since the file server 1141 in the mobile router 100 serves as an external hard disk for the mobile terminal 200.

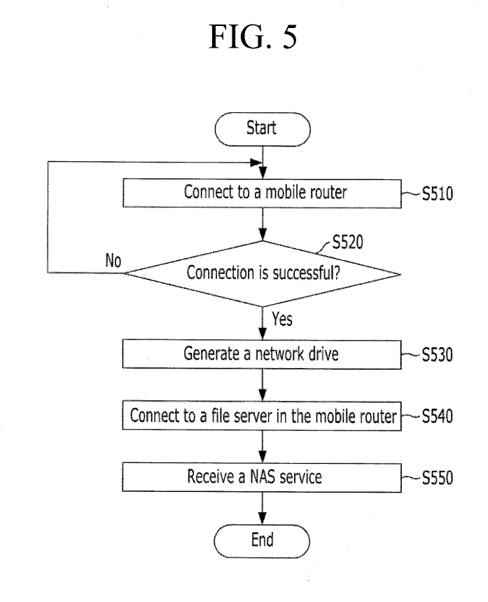

FIG. 5 illustrates a mobile service method of a mobile terminal, in accordance with an embodiment of the present invention.

Referring to FIG. 5, the mobile terminal 200 may attempt to connect to the mobile router 100 S510. For example, the mobile terminal 200 may attempt to connection to the mobile router 100 through the connection unit 211 in order to access the Internet and receive a network storage service.

When the connection to the mobile router 100 is determined to be successful (S520—YES), the mobile terminal 200 may generate a network drive for a NAS service S530. For example, when the mobile terminal 200 succeeds in establishing a connection to the mobile router 100 through the connection unit 211, the network drive generation unit 212 may generate the network drive in the mobile terminal 200.

The mobile terminal 200 may connect to the file server 1141 in the mobile router 100 through the generated network drive S540. Then, the mobile terminal 200 may receive the NAS service from the file server 1141 S550.

In accordance with an embodiment of the present invention, a mobile terminal may not only connect to a mobile router for Internet access, but may also receive a network storage service from the mobile router by generating a network drive when the connection to the mobile router is completed.

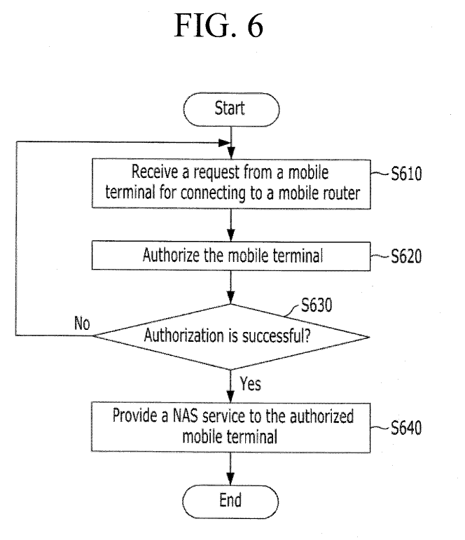

FIG. 6 illustrates a mobile service method of a mobile router, in accordance with an embodiment of the present invention.

Referring to FIG. 6, a request from the mobile terminal 200 for connecting to the mobile router 100 may be received S610. For example, the mobile terminal 200 may request a connection to the mobile router 100 through the connection unit 211 in order to receive a network storage service.

Then, an authorization of the mobile terminal 200 requesting the connection to the mobile router 100 may be performed S620. For example, the mobile router 100 may determine whether or not the mobile terminal 200 that requested the connection to the mobile router 100 is an authorized user who can access the file server 1141.

If the authorization is determined to be successful (S630—YES), the mobile router 100 may provide a NAS service to the authorized mobile terminal 200 S640. For example, when the mobile router 100 authorizes the mobile terminal 200 to connect to the file server 1141, the file server 1141 may provide the network storage service to the authorized mobile terminal 200.

Furthermore, the mobile router 100 may determine whether or not a packet received from the mobile terminal 200 is a NAS service related packet. If the packet from the mobile terminal 200 is determined to be a NAS service related packet, the packet may be transmitted to the file server 1141. On the other hand, if the packet received from the mobile terminal 200 is not a NAS service related packet, the packet may be processed by the mobile communication processor 1122, transmitting to the Internet over the mobile communication network.

In accordance with embodiments of the present invention, the mobile router may provide both a routing function and a network storage service to a mobile node in a mobile network system. Therefore, a separate file server for providing a NAS service is not required, leading to a reduction in network complexity.

When a component is mentioned as being “connected” and “coupled” to or “accessing” another component, this may mean that it is directly connected to or accessing the other component, but it is to be understood that one or more other components may exist therebetween. On the other hand, when a component is mentioned as being “directly connected” to or “directly accessing” another component, it is to be understood that there are no other components therebetween.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile service apparatus for providing a mobile service to a mobile node in a mobile communication network, the apparatus comprising:
a routing function unit configured to function as a mobile access point for the mobile node; and
a storage function unit configured to authorize the mobile node to access the mobile service apparatus, and configured to provide a storage service to the authorized mobile node.

2. The mobile service apparatus of claim 1, wherein the storage function unit comprises a network-attached storage configured to provide a file-level data storage service.

3. The mobile service apparatus of claim 2, wherein the storage function unit further comprises:
a storage unit configured to store files; and
a file server unit configured to control at least one of a file transmission and a file reception between the authorized mobile node and the mobile service apparatus.

4. The mobile service apparatus of claim 1, further comprising:
a routing controller configured to communicate a variety of commands between the routing block and the storage block.

5. The mobile service apparatus of claim 1, wherein the routing function unit comprises:
a processing unit configured to transmit a data packet from the authorized mobile node to the storage block if the data packet is related to the storage service.

6. A system for providing a mobile service in a mobile communication network, the system comprising:
a mobile router configured to provide both an Internet access and a storage service to a mobile node in the mobile communication network,
wherein the mobile node is configured to connect to the mobile router for the Internet access, and is configured to receive the storage service from the mobile router.

7. The system of claim 6, wherein the mobile router comprises:
a routing function unit configured to function as a mobile access point for the mobile node; and
a storage function unit configured to authorize the mobile node to access the mobile router to provide the storage service to the authorized mobile node.

8. The system of claim 7, wherein the storage function unit comprises a network-attached storage configured to provide a file-level data storage service.

9. The system of claim 8, wherein the storage function unit further comprises:
a storage unit configured to store files; and
a file server unit configured to control at least one of a file transmission and a file reception between the authorized mobile node and the mobile router.

10. The system of claim 7, wherein the routing function unit comprises:
a processing unit configured to transmit a data packet from the authorized mobile node to the storage block if the data packet is related to the storage service.

11. The system of claim 7, wherein the mobile router further comprises:
a routing controller configured to communicate a variety of commands between the routing block and the storage block.

12. The system of claim 6, wherein the mobile node comprises:
a connection unit configured to perform a connection to the mobile router; and
a file sharing unit configured to request the storage service to be provided to the mobile router, and configured to receive the storage service from the mobile router.

13. The system of claim 12, wherein the mobile node further comprises:
a network drive generation unit configured to generate a network drive when the connection of the mobile node to the mobile router has been established.

14. The system of claim 12, wherein the file sharing unit comprises a connection module configured to connect to a file server in the mobile router.

15. A method of providing a mobile service in a mobile communication network, the method comprising:
receiving a request from a mobile node for connecting to a mobile router;
authorizing the mobile node to access the mobile router;
connecting the authorized mobile node to a file server in the mobile router; and
providing a storage service to the authorized mobile node.

16. The method of claim 15, wherein the storage service comprises a file-level data storage service.

17. The method of claim 16, further comprising:
generating a signal path from the authorized mobile node to the file server when the connection of the authorized mobile node to the file server has been established.

18. The method of claim 17, wherein the generating the signal path from the authorized mobile node to the file server comprises:
generating a network drive in the authorized mobile node to connect to the file server.

19. The method of claim 17, wherein the generating the signal path from the authorized mobile node to the file server comprises:
converting a status of a connection module in the authorized mobile node into an active status to connect the authorized mobile node to the file server.

20. The method of claim 15, wherein the providing the storage service to the authorized mobile node comprises:
storing files transmitted from the authorized mobile node in the file server; and
receiving, at the authorized mobile node, a desired file from the file server.
